(19) United States
(12) Patent Application Publication
(10) Pub. No.: US 2012/0078214 A1
(43) Pub. Date: Mar. 29, 2012

(54) VIAL TRANSFER NEEDLE ASSEMBLY

(75) Inventors: Mel Finke, Deland, FL (US); Jonathan G. Parker, DeBary, FL (US); Carl Strickland, Deland, FL (US); John K. Foster, Port Orange, FL (US)

(73) Assignee: TYCO HEALTHCARE GROUP LP, Mansfield, MA (US)

(21) Appl. No.: 12/891,930

(22) Filed: Sep. 28, 2010

(51) Int. Cl. A61J 1/20

(52) U.S. Cl. 604/411

(57) ABSTRACT

The present disclosure relates to a vial transfer needle assembly that includes a housing and a vial access member. The housing includes a proximal skirt and a distal skirt that is connected by a central hub portion. The central hub portion defines a central bore that extends between the proximal skirt and the distal skirt. The central bore of the housing includes an annular bead, a side wall, and a shoulder. The vial access member is disposed within the central bore of the housing such that the top surface of the flange is positioned underneath the annular bead of the central bore to thereby secure the vial access member within the housing.

### BACKGROUND

1. Technical Field

The present disclosure relates to a vial transfer needle assembly, more particularly, to a vial transfer needle assembly having a two-piece arrangement.

2. Description of Related Art

In the medical field, certain types of solutions (e.g., drugs) are commonly stored in vials that utilize a pierceable cap (e.g., resealable septum) on one end and a plunger that is inserted into the opposite end. It is common for a clinician to use a vial transfer needle assembly that includes a spike or needle on one end and a standard threaded female luer connecter on the other end to fluidly couple the vial to a medical device, e.g., syringe, catheter, hubbed needle, etc.

Currently vial transfer needle assemblies are manufactured by utilizing a three-piece design, which generally includes a plastic hub portion, a metal needle (e.g., a cannula), and a crimp-on metal insert that is used to capture the needle and seat it within the plastic hub portion. A sheath component may be pressed over the luer taper and serves as a sterile fluid path barrier when the hub is assembled to a vial.

It would be beneficial to decrease the amount of parts needed for a vial transfer needle assembly and to simplify the assembly process.

### SUMMARY

The present disclosure relates to a vial transfer needle assembly that includes a housing and a vial access member. The housing includes a proximal skirt and a distal skirt that is connected by a central hub portion. The central hub portion defines a central bore that extends between the proximal skirt and the distal skirt. The central bore of the housing includes an annular bead, a side wall, and a shoulder. The vial access member is disposed within the central bore of the housing such that the top surface of the flange is positioned underneath the annular bead of the central bore to thereby secure the vial access member within the housing.

The vial access member includes a tapered body portion on a first end, a piercing tip on a second end and a flange that is disposed therebetween the first end and the second end. The flange includes a top surface, a side surface and a shoulder. The vial access member defines a lumen therebetween for allowing fluid to pass therethrough.

The vial access member is disposed within the central bore of the housing such that the top surface of the flange is positioned underneath the annular bead of the central bore to thereby secure the vial access member within the housing.

In embodiments, the shoulder of the vial access member is configured to securely abut the corresponding shoulder of the central bore of the housing.

In other embodiments, the proximal skirt includes an inner wall and a base that together define a first cavity. The inner wall of the proximal skirt has an annular bead that is disposed along an inner periphery of the inner wall to facilitate releasable engagement with a vial when the vial is inserted within the cavity of the proximal skirt. The distal skirt has an inner wall and a base that together define a second cavity. The inner wall of the distal skirt has a plurality of threads.

In other embodiments, the vial access member may be made from a rigid injection molded plastic or a metal. The vial access member may include a first colorant and the housing may include a second colorant. The distal skirt may be configured to engage a catheter tube assembly. The distal skirt further includes a distal luer taper that projects from base and defines a lumen. The distal luer taper being configured to be received within the catheter tube assembly.

In embodiments, a cover may be disposed over the opening defined by an outer periphery of the proximal skirt to prevent contaminants from entering the opening of the proximal skirt.

### BRIEF DESCRIPTION OF THE DRAWINGS

Various embodiment of the subject instrument are described herein with reference to the drawings wherein:

FIG. 1 is a perspective view of a vial transfer needle assembly according to one embodiment of the present disclosure;

FIG. 2 is a side cross-sectional view of the vial transfer needle assembly of FIG. 1;

FIG. 3 is an exploded view showing parts of the vial transfer needle assembly of FIG. 1;

FIG. 4A is a perspective view of the vial transfer needle assembly shown in FIG. 1 with a cover disposed over a cavity of a proximal skirt;

FIG. 4B is a perspective view of the vial transfer needle assembly shown in FIG. 4A with the cover partially removed therefrom; and

FIG. 5 is a side cross-sectional view of a vial plunger, a catheter assembly, and the vial transfer needle assembly being coupled together and shown during use in accordance with an embodiment of the present disclosure.

### DETAILED DESCRIPTION

Embodiments of the presently disclosed vial transfer needle assembly are described in detail with reference to the drawings wherein like reference numerals identify similar or identical elements. As used herein, the term “distal” refers to that portion of the device which is further from a user while the term “proximal” refers to that portion of the device which is closer to a user.

The present invention is directed to a vial transfer needle. In order to release the solution from the vial, one end of the vial transfer needle assembly is snapped over the pierceable cap such that the spike of the vial transfer needle assembly pierces the septum of the cap. On the opposite end of the vial transfer needle assembly, a medical device is connected to the standard threaded female luer connection. A plunger in the vial may then pressed into the vial to transfer the contents of the vial through the vial transfer needle assembly and into the medical device for delivery to the patient. Alternatively, the medical device, such as a syringe, connected to the threaded female leur connection may withdraw the contents from a vial through the vial transfer needle into the medical device for delivery to the patient. It is understood that the vial transfer needle of the present invention may also be used in conjunction with a plungerless vial, in which the transfer needle may also comprise self-venting features. One example of a self-venting needle is disclosed in U.S. patent application Ser. No. 12/891,885, entitled SELF-VENTING CANNULA ASSEMBLY, and filed on Sep. 28, 2010, the entirety of which is incorporated herein by reference for all purposes.

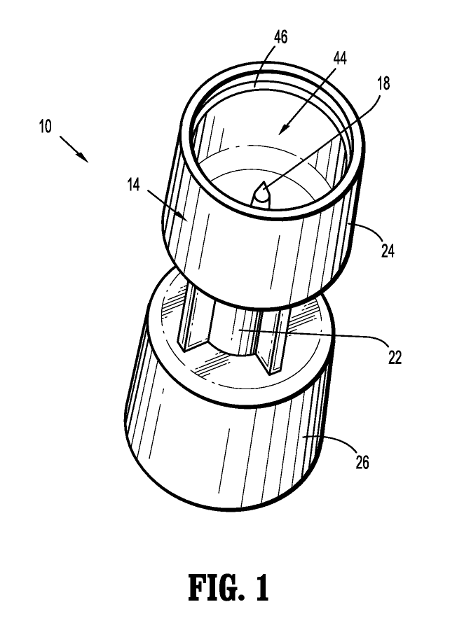

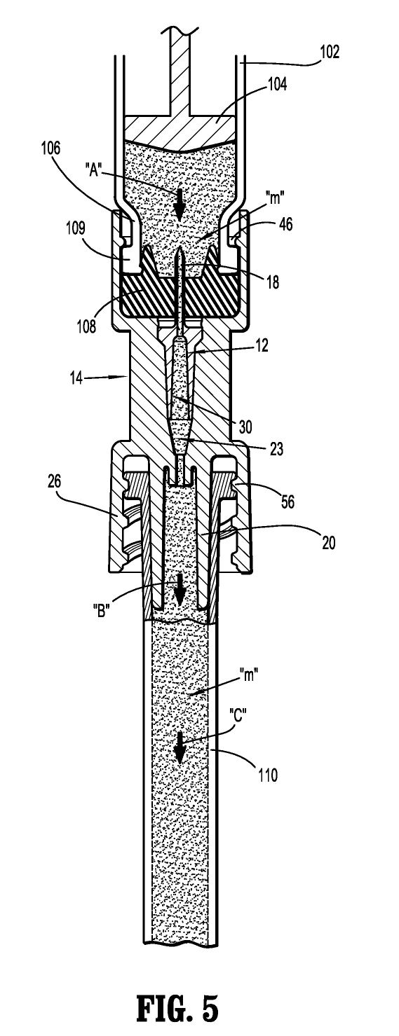

Referring initially to FIGS. 1-3, a vial transfer needle assembly is shown and generally depicted as 10. Vial transfer needle assembly 10 is provided for transferring fluid from a vial 102 having a plunger 104 (FIG. 5) to a medical device. The medical device may be any medical device constructed and arranged to receive the contents of the vial and to mate to releasably mate to the transfer needle assembly 10. For example, the medical device may be a needleless syringe or a catheter. In one embodiment shown in FIG. 5, the medical device is a catheter tube 110. Vial transfer needle assembly 10 generally includes a vial access member 12 that is secured to a housing 14, for example, in a snap-fit fashion.

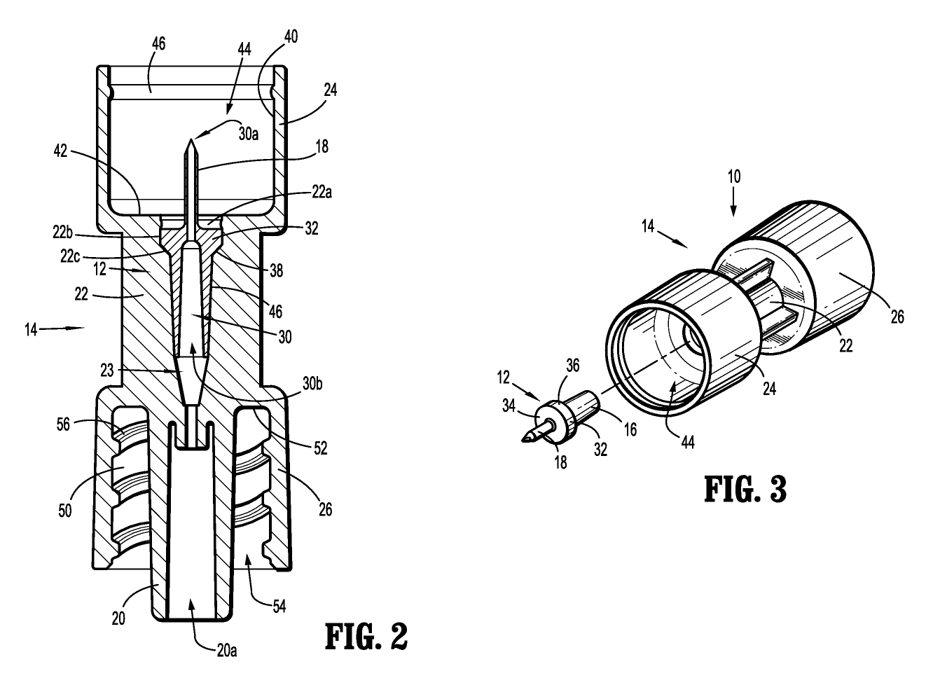

Referring now to FIGS. 2 and 3, vial access member 12 generally includes a tapered body portion 16 on one end and a piercing tip 18 on the other end. Between body portion 16 and piercing tip 18, vial access member 12 includes a flange 32, which is configured and dimensioned to engage a corresponding shoulder 22c of housing 14 to support vial access member 12 within housing 14. Piercing tip 18 is configured to pierce a pierceable septum of vial 102 (FIG. 5). Piercing tip may comprise any desired shape able to pierce the septum of the vial and to transfer the contents of the vial. The piercing tip 18 may be a blunt or sharp tipped. In one embodiment, the piercing tip 18 is constructed and arranged to minimize or prevent coring of the septum during piercing.

Body portion 16 of vial access member 12 is configured to be received within a central hub portion 22 of housing 14. In embodiments, vial access member 12 is made from a hard material (e.g., an injection molded plastic or metal) to provide a rigid structure for the proximal piercing tip 18 and body portion 16. In one embodiment, the vial access member is integrally formed of a molded plastic. In another embodiment, the vial access member is formed of the same material as the housing 14.

In embodiments, different colors may be used to distinguish vial access member 12 from housing 14. For example, vial access member 12 may include one colorant, while housing 14 may include a different colorant. In one embodiment, vial access member having a particular piercing tip configuration may be associated with one color, while a vial access member having a different piercing tip configuration may be associated with a different color.

As discussed above, body portion 16 of vial access member 12 includes flange 32 which is positioned about its outer periphery and configured to securely abut corresponding shoulder 22c of central hub portion 22 of housing 14. More specifically, flange 32 includes a flat surface 34, a side surface 36 and an angled surface or shoulder 38, as will be discussed in further detail below.

Still referring to FIGS. 2 and 3, housing 14 includes central hub portion 22, a proximal skirt 24, and a distal skirt 26. Proximal skirt 24 includes an inner wall 40 and a base 42 which together define a first cavity 44. Inner wall 40 includes an annular bead 46 that is disposed along an inner periphery of inner wall 40. Annular bead 46 is provided to facilitate releasable engagement of vial 102 within cavity 44 of proximal skirt 24. Alternately, other structure may be provided to releasably retain a vial within cavity 44.

Distal skirt 26 includes an inner wall 50 and a base 52 that together define a second cavity 54. Inner wall 50 includes a plurality of threads 56 that are disposed alongside inner wall 50 in a helical fashion such that a luer connector of a medical device such as a catheter tube 110 (FIG. 7) may be connected thereto. Alternately, other known structure may be used to releasably engage a medical device. Distal skirt 26 further includes a distal luer taper 20 that projects from base 52 and extends through second cavity 54. Distal luer taper 20 defines a lumen 20a and is configured to be received within a catheter tube 110 (shown in FIG. 7).

As shown in FIG. 2, central hub portion 22 defines a bore 23 that extends between proximal skirt 24 and distal skirt 26. Bore 23 of central hub portion 22 is configured and dimensioned to receive vial access member 12. A top portion of bore 23 of central hub portion 22 includes an annular bead 22a, a side surface 22b and an inwardly facing angled wall or shoulder 22c. Vial access member 12 is inserted into bore 23 of central hub portion 22 until tapered body portion 16 abuts the tapered bottom portion of bore 23 of central hub portion 22. In addition, in order to provide a secure fit of vial access member 12 within bore 23 of central hub portion 22, flange 32 of vial access member 12 may be snap-fitted over annular bead 22a such that side surface 36 of flange 32 and side surface 22b of central hub portion 22 are in engagement with each other. In this configuration, annular bead 22a is positioned above flat surface 34 of flange 32 to maintain shoulder 38 of flange 32 in engagement with inwardly facing angled surface or shoulder 22c of central hub portion 22.

Housing 14 may be formed of any material suitable to support the vial access member and support contact with the vial and the medical device. In one embodiment, the housing is integrally formed of a molded plastic.

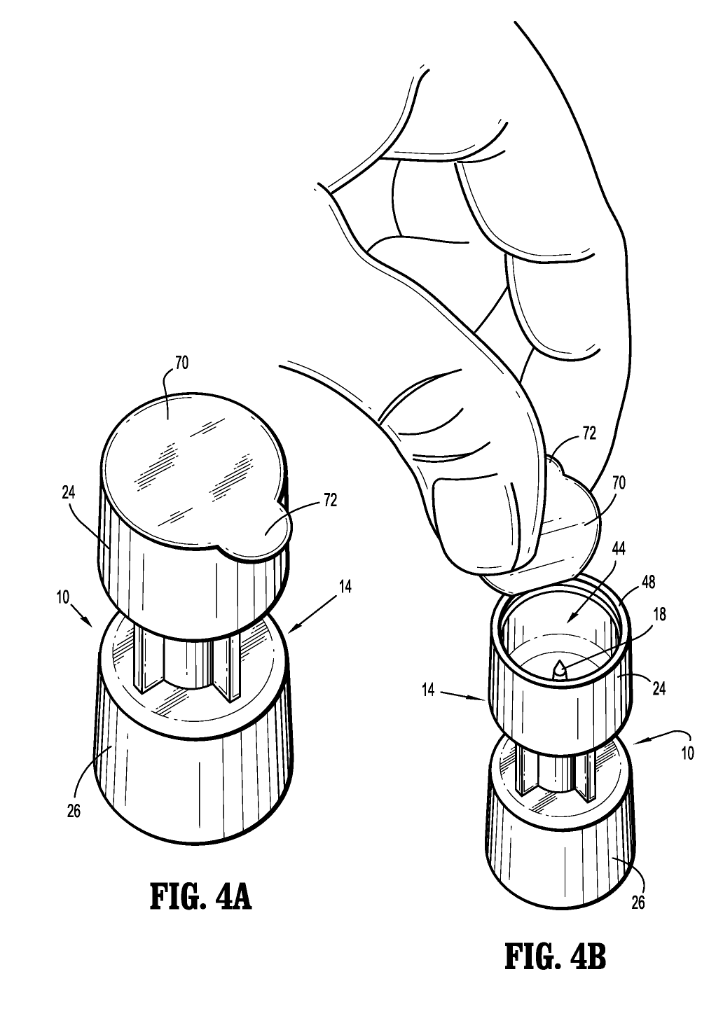

Referring to FIGS. 4A and 4B, in embodiments, a cover 70 may be disposed over the opening defined by an outer periphery 48 of proximal skirt 24. Cover 70 may have a pull tab 72 and is configured to prevent any contaminants from entering cavity 44 of proximal skirt 24 during packaging and before a surgical procedure is performed. Alternatively, or in addition to the cover 70 over the opening defined by an outer periphery 48 of proximal skirt 24, a cover (not shown) may be disposed over the opening defined by an outer periphery of distal skirt 26. The one or more covers may be formed of conventional materials such as coated papers, films, and combinations thereof. The one or more covers may be releasably attached to the one or more skirts by conventional methods, including the use of adhesives or heat seal films.

Referring to FIG. 5, as it is commonly known in the art, vial 102 may contain a medicinal fluid “M” or any other suitable types of fluids. As it is also commonly known in the art, vial 102 may include a plunger 104, a neck portion 106, a pierceable septum 108 and a rim 109.

During use, a clinician removes (e.g., peels off) cover 70 from outer periphery 48 of proximal skirt 24 and inserts vial 102 within cavity 44 of proximal skirt 24. As vial 102 is inserted within cavity 44, rim 109 of vial 102 is pushed over annular bead 46 until rim 109 of vial 102 abuts base 42 of the proximal skirt 24. In this position, proximal piercing tip 18 pierces the pierceable septum 108 of vial 102 to thereby allow medicinal fluid “M” to pass through proximal lumen 30a.

In one embodiment, the assembly of an integrally molded housing and an integrally molded vial access member simplifies the manufacturing process by reducing the number of parts conventionally assembled in the manufacture of vial transfer devices. In addition, the assembly of the integrally molded housing and the integrally molded vial access member provides manufacturing versatility, in that vial access members with different piercing tip configurations may interchanged in the assembly process depending on the desired configuration of the piercing tip of the vial transfer needle.

The clinician then secures a medical device, e.g., a cannula tube 110, to distal skirt 26 via luer threads 56 such that distal luer taper 20 is disposed within cannula tube 110. Afterwards, plunger 104 of vial 102 is depressed such that the medicinal fluid “M” travels from vial 102 (as shown by arrow “A”), through central hub portion 16 via lumen 30, through distal luer taper 20 (as shown by arrow “B”) via lumen 20a, and ultimately into catheter tube 110 (as shown by arrow “C”).

It will be understood that various modification may be made to the embodiments disclose herein. For example, the length of the disclosed tapered body portion of vial access member and the dimensions of the disclosed bore of central body portion may vary. Therefore, the above description should not be construed as limiting, but merely as exemplifications of embodiments. Those skilled in the art will envision other modification within the scope and spirit of the claims appended hereto.

What is claimed:

1. A vial transfer needle assembly comprising:
a housing including a proximal skirt and a distal skirt connected by a central hub portion, the central hub portion defining a central bore extending between the proximal skirt and the distal skirt, the central bore of the housing including an annular bead, a side wall, and a shoulder; and
a vial access member including a tapered body portion on a first end, a piercing tip on a second end and a flange disposed therebetween, the flange including a top surface, a side surface and a shoulder, the vial access member defining a lumen which extends from the piercing tip through the tapered body portion for allowing fluid to pass therethrough,
wherein the vial access member is disposed within the central bore of the housing such that the top surface of the flange is positioned underneath the annular bead of the central bore to thereby secure the vial access member within the housing.

2. The vial transfer needle assembly according to claim 1, wherein the shoulder of the vial access member is configured to securely abut the corresponding shoulder of the central bore of the housing.

3. The vial transfer needle assembly according to claim 1, wherein the proximal skirt includes an inner wall and a base that together define a first cavity, the inner wall of the proximal skirt having an annular bead disposed along an inner periphery of the inner wall to facilitate releasable engagement with a vial when the vial is inserted within the cavity of the proximal skirt, the distal skirt having an inner wall and a base that together define a second cavity, the inner wall of the distal skirt having a plurality of threads.

4. The vial transfer needle assembly according to claim 1, wherein the vial access member is made from a rigid molded plastic.

5. The vial transfer needle assembly according to claim 1, wherein the vial access member is made from a metal.

6. The vial transfer needle assembly according to claim 1, wherein the vial access member includes a first colorant and the housing includes a second colorant.

7. The vial transfer needle assembly according to claim 1, wherein the distal skirt is configured to engage a catheter tube assembly.

8. The vial transfer needle assembly according to claim 1, wherein the distal skirt further includes a distal luer taper that projects from base and defines a lumen, the distal luer taper extending through the distal skirt being configured to be received within the catheter tube assembly.

9. The vial transfer needle assembly according to claim 1, wherein a cover is disposed over an opening defined by an outer periphery of the proximal skirt to prevent contaminants from entering the opening of the proximal skirt.

10. The vial transfer needle assembly according to claim 4, wherein the housing is formed of a rigid molded plastic.
